(19) United States
(12) Patent Application Publication
(10) Pub. No.: US 2005/0073978 A1
(43) Pub. Date: Apr. 7, 2005

(54) Apparatus and method for receiving data through channels in mobile communication system

(76) Inventors: Min-Goo Kim, Yongin-si (KR); Hye-Jeong Kim, Yongin-si (KR); Sang-Hyuck Ha, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/959,137

(22) Filed: Oct. 7, 2004

(30) Foreign Application Priority Data
Oct. 7, 2003 (KR) 2003-69742

(51) Int. Cl. H04Q 7/00; H04B 7/216

(52) U.S. Cl. 370/335; 370/342

(57) ABSTRACT

An apparatus for receiving data through channels in a communication system including a first channel for transmitting control information related to a second channel and the second channel for transmitting packet data, the apparatus comprising: a first channel decoder for decoding the first channel and outputting control information; an active Walsh mask storing section for storing a Walsh mask acquired from the control information; a second channel decoder for decoding the second channel using the Walsh mask stored in the active Walsh mask storing section and outputting a decoding result; and a control unit for changing the Walsh mask to a previous Walsh mask if a Walsh mask error is determined according the decoding result.

### CROSS-REFERENCE TO RELATED APPLICATION

This application claims the benefit under 35 U.S.C. §119(a) to an application entitled “Apparatus And Method For Receiving Walsh Masking Information In Mobile Communication System” filed with the Korean Intellectual Property Office on Oct. 7, 2003 and assigned Serial No. 2003-69742, the entire contents of which are incorporated herein by reference.

### BACKGROUND OF THE INVENTION

1. Field of the Invention

The present invention relates to an apparatus and a method for receiving a channel transmitted from a packet data transmission system, and more particularly to an apparatus and a method for receiving data through channels.

2. Description of the Related Art

Synchronous CDMA mobile communication systems are divided into systems capable of providing a realtime traffic, such as voice; systems capable of providing a non-realtime traffic, such as low-speed packet data less than 14.4 kbps or high-speed packet data; and systems capable of providing packet data as well as voice.

Such a division for synchronous CDMA mobile communication systems has been realized to satisfy user's demand for packet data transmission services that match technical developments. Therefore, current mobile communication systems can provide high-speed packet data services in addition to voice services.

A mobile communication system, such as a Evolution Data Only (1xEV DO) system, provides a high-speed packet data service. However, the 1xEV DO system does not provide a voice service simultaneously with the high-speed packet data service. For this reason, a 1xEV-DV system capable of providing a high-speed packet data service as well as a voice service has been suggested.

Since the 1xEV-DV system provides voice data and non-realtime data, it is necessary to determine the priority of the voice data and non-realtime data when transmitting the voice data and non-realtime data. Priority for data transmission must be determined by taking quality of service (QoS) of each service into consideration in such a manner that voice data requiring high-speed transmission is provided to users prior to the non-realtime data. Hereinafter, a conventional 1xEV-DV system for transmitting packet data will be described.

FIG. 1 is a schematic view illustrating channels aligned between a base station and a mobile station in a CDMA 2000 1xEV-DV system.

According to the CDMA 2000 1xEV-DV standard, which is a standard for a synchronous CDMA mobile communication system, a forward packet data channel (F-PDCH) for transmitting packets and a forward packet data control channel (F-PDCCH) for transmitting control information for a packet data transmission service are forwardly set between a base station 100 and mobile stations (MS1, MS2, MS3) 110, 120 and 130. In addition, a reverse-channel quality information channel (R-CQICH) and a reverse-acknowledge channel (R-ACKCH) for transmitting acknowledgement information for the packet data are reversely set between the base station 100 and mobile stations MS1, MS2, MS3 110, 120 and 130, respectively.

The F-PDCCH is a physical channel for transferring a control message when a base station has a packet to be transferred to a mobile station. A transmission duration and a transmission instant of the F-PDCCH are identical to those of the F-PDCH transferring traffic, such as a packet. The F-PDCCH has three transmission durations of 1.25 msec corresponding to 1 slot, 2.5 msec corresponding to 2 slots, and 5.0 msec corresponding to 4 slots. The transmission duration is selected corresponding to each transmission instant by detecting channel information, such as a carrier to noise ratio (CNR), a carrier to interference ratio (CIR), a buffer state of data to be transmitted using a scheduler of a base station, any other suitable channel information or combination thereof.

In addition, a control message transmitted through the F-PDCCH includes information allowing a receiver to precisely recognize Walsh covering information used in a CDMA transmitter as well as information for F-PDCH. The Walsh covering information is used for transferring Walsh information of a base station to a mobile station connected to the base station. The Walsh covering information is called a Walsh mask using 13-bit information. If 8-bit medium access control layer identifications (MAC IDs) are all “0”, a base station transfers Walsh mask information used in the base station to 13-bit forward packet data control information of the F-PDCCH. In addition, if 8-bit MAC IDs are not “0”, the base station transmits a control message, such as packet size information for the F-PDCH transmitted from the base station or coding rate information, to 13-bit information. Thus, the mobile station checks a MAC_ID whenever decoding the F-PDCCH, and determines whether a value of the MAC_ID is “0” in such a manner that the mobile station operates according to the value of the MAC_ID.

Hereinafter, a transmitter for transmitting forward packet data control channel information will be described with reference to FIG. 2. Referring to FIG. 2, forward packet data control channel information bits are randomized at a field 200 by means of a system time (SYSTEM_TIME) so that they are converted into a random sequence. The 13-bit random numbers are received in every interval of 1.25 msec from the system time.

In addition, a cyclic redundancy check (CRC) is added to the F-PDCCH in order to detect an error from the signal created at the field 200. The F-PDCCH CRC includes a 8-bit inner frame quality indicator and a 8-bit outer frame quality indicator.

As shown in FIG. 2, the outer frame quality indicator is transmitted while preferably being exclusive-ORed at field 210 by means of a 8-bit specific binary pattern called an medium access control layer identification (MAC_ID). The MAC_ID is a unique number used by the base station to recognize a mobile station. The inner frame quality indicator is added at field 220. In addition, 8 encoder tail bits are used at field 230 for a zero state termination of convolution codes. That is, after the 13-bit information and the 8 encoder tail bits have been input, the convolution codes are terminated with a zero state of trellis.

The convolution codes are used at field 240 to correct an error in the control message caused by noise generated from the transmission channel. Transmission durations corresponding to 1 slot, 2 slots and 4 slots are represented as n=1, 2 and 4. A symbol repetition 250 and symbol puncturing 260 of the forward packet data control channel may operate differently according to the transmission durations. A channel block interleaver is used at a field 270 to distribute a burst error created in the reception signal caused by a multipath fading channel. FIG. 3 is a view illustrating structures of a transmitter and a receiver for the F-PDCCH in a CDMA 2000 1xEV-DV using the F-PDCCH. Referring to FIG. 3, a symbol repetition and puncturing 330 is identical to the symbol repetition 250 and the symbol puncturing 260 shown in FIG. 2. In addition, a symbol combining and erasure insertion 360 signifies a functional block performing a reverse procedure of the symbol repetition and puncturing used in the receiver for the F-PDCCH. In addition, the receiver restores an original order of channel-interleaved symbols through a channel de-interleaver 350. A Viterbi decoder 370 is used in the receiver for decoding convolution codes.

It is noted that the base station 100 does not transmit slot format information (SFI) of the determined F-PDCCH to a mobile station receiving a service. Thus, an F-PDCCH receiver of the mobile station must detect the SFI of the base station 100 from an F-PDCCH reception signal. Such a transmission duration detection scheme of the mobile station is called a “blind slot format detection (BSFD) 390”.

The receiver shown in FIG. 3 may detect F-PDCCH information through two ways.

First, the receiver detects an inner CRC from the 13-bit information, which has been decoded through the Viterbi decoder 370, and 8-bit CRC-covered MAC_ID. The receiver can detect information words based on an inspection result of the inner CRC.

Second, after detecting the inner CRC through the above first method, an outer CRC and an MAC_ID are detected. The outer CRC and MAC_ID are compared with the inner CRC and 8-bit CRC-covered MAC_ID so as to detect information words.

In a case of a high-speed data transmission, a fast hybrid automatic repeat request (FHARQ) is used in order to improve performance of a physical channel. According to the FHARQ scheme, N ARQ channels are used. An FHARQ including four ARQ channels (N=4) is used as a standard of a 1xEV-DV system. FIG. 4 shows an example of the FHARQ having ARQ channels.

The base station, that is, the transmitter can continuously transmit a maximum of four HARQs. Referring to FIG. 4, the transmitter transmits packet data 400 to mobile station A at a point of T0. In addition, upon receiving an ACK/NACK message 410 from mobile station A, the transmitter transmits new packet data or retransmits the packet data, which has been transmitted to mobile station A at the point of T0, to the mobile station A at a point of T4. Thus, the base station can transmit new packet data to each of three mobile stations B, C and D regardless of the success of the packet data transmission. Such a transmission scheme is called a “user diversity scheme”. According to the user diversity scheme, a channel resource can be used as effectively as possible.

FIG. 5 shows another example of the FHARQ having four ARQ channels (N=4) and using the user diversity scheme. Referring to FIG. 5, if there are no plural users requesting packet services, the base station stops the transmission of the F-PDCCH, so only noise may exist between T0 and T1.

Referring to FIG. 6, the base station employing the HARQ scheme (N=4) can continuously transmit four new packets to one mobile station A. In this case, the mobile station A may continuously receive the packets, so all F-PDCCHs received during a no operation interval (NOI) are employed for the mobile station A.

Herein, it is noted that the mobile station A shown in FIG. 4 is not supposed to perform any functions because the F-PDCCHs received during the NOI are not allocated to the mobile station A, but allocated to mobile stations B, C and D. In addition, the mobile station A shown in FIG. 5 is not supposed to act as an F-PDCCH receiver because noise received during the NOI, in which the F-PDCCH is not transmitted, is meaningless. That is, the mobile station must receive the F-PDCCH allocated thereto and must perform an operation according to a transmission rule.

According to the CDMA 2000 1xEV-DV standard, a mobile station employing an F-PDCH for transmitting a packet decodes data of the F-PDCH only when an F-PDCCH is allocated to the mobile station and transmits a response signal of ACK or NAK through a reverse channel according to the decoding result. However, in practice, the mobile station represents the following errors due to noise and signal distortion created in a channel.

First, the mobile station selected by the base station may not normally receive the F-PDCCH due to noise or signal distortion. That is, the mobile station may not receive packets due to an F-PDCCH error, which results in the mobile station not recognizing the transmission of the F-PDCH, or the mobile station may fail to decode the F-FDCH due to an erroneous control message even if the mobile station receives the F-PDCH. In this case, the mobile station transmits an NAK message in the reverse direction.

That is, referring back to FIG. 4, even if the packet data is received in the receiver at a point of T3, the receiver may transmit the NAK message to the base station. In this case, since the base station transmits a retransmitted packet according to a retransmission scheme defined in the standard, problems may not occur.

Second, the mobile station selected by the base station may not normally receive the F-PDCCH due to noise or signal distortion while misconceiving MAC_IDs as “all zero”, that is, as Walsh mask update information. At this time, the mobile station changes its Walsh mask. In this state, if the mobile station receives the F-PDCH, an F-PDCH decoding error may occur due to a Walsh decoding error. Therefore, the mobile station continuously transmits the NAK message in the reverse direction if the Walsh mask is not again updated. That is, in both the first and second cases, the mobile station transmits the NAK message to the base station. Referring to FIG. 7, the mobile station erroneously updates the Walsh mask thereof due to a false alarm of the F-PDCCH generated at the point of T1 and continuously generates the F-PDCH error from T1 to T2.

In this case, the mobile station selected by the base station continuously generates an F-PDCH reception error due to erroneous Walsh mask information until the base station again transmits Walsh mask information to the mobile station. Therefore, the mobile station must self-diagnose and correct the Walsh mask error caused by the F-PDCCH error.

Third, a mobile station, which is not selected by the base station, may misconceive the received F-PDCCH as its own F-PDCCH due to noise or signal distortion. In this case, the mobile station erroneously determines that the F-PDCH has been transmitted thereto, so the mobile station performs a decoding operation for the F-PDCH, but fails in the decoding operation and transmits the NAK message to the base station in the reverse direction. Referring again to FIG. 5, although the mobile station transmits the ACK/NAK message to the base station in response to packet data 500 received in the mobile station at the point of T3, the mobile station transmits an erroneous ACK/NAK message to the base station at a point of T5 due to noise generated during the NOI.

Fourth, the mobile station, which is not selected by the base station, determines that the received F-PDCCH is its own F-PDCCH due to noise or signal distortion while misconceiving MAC_IDs as “all zero”, that is, as Walsh mask update information due to the F-PDCCH error. At this time, the mobile station changes its Walsh mask. In this state, if the mobile station receives the F-PDCH, an F-PDCH decoding error may occur due to a Walsh decoding error. Therefore, the mobile station continuously transmits the NAK message in the reverse direction if an accurate Walsh mask is not again updated.

In both third and fourth cases, since the base station precisely knows the MAC_ID of a mobile station, which is designated as a mobile station receiving the packet from the base station, if a MAC_ID of a mobile station transmitted through a reverse channel is different from the MAC_ID of the designated mobile station, the base station does not act while disregarding the received NAK message, so problems may not occur in a forward channel.

However, if a non-designated mobile station occupies a reverse ACK channel (R-ACKCH) for transmitting the ACK/NAK message and a reverse channel quality indicator channel (R-CQICH) for transmitting the CIR, reverse channel resources are unnecessarily wasted and signal quality is lowered due to the interference of other normal mobile stations in relation to the R-ACKCH.

As mentioned above, in the CDMA 2000 1xEV-DV system, the base station broadcasts the Walsh mask to mobile stations provided in a corresponding cell at a predetermined time in accordance with the variation of the number of Walsh channels to be allocated to the F-PDCH, which is a packet channel. Therefore, if the NAK message is continuously transmitted to the base station from a specific mobile station, the base station determines that the specific mobile station requests retransmission of packet data due to an inferior channel status or a packet transmission error. Thus, the base station continuously transmits retransmitted packets within a maximum retransmission range. If the base station receives the NAK message even though it transmits retransmitted packets within the maximum retransmission range, the base station determines that the transmitted packet has an error. Thus, the base station transmits a new packet or retransmits the packet causing the NAK message. However, the NAK message is rarely generated more than several times with regard to the same packet. Accordingly, if the NAK message is generated more than several times, it is determined that the Walsh mask error occurs due to the MAC_ID error. Such a MAC_ID error may cause a serious problem, but the MAC_ID error is not taken into consideration in the current mobile communication system. Although it is possible to periodically propagate the Walsh mask with a short time interval, the efficiency of the channel in use may be significantly reduced. Therefore, it is necessary for the base station to effectively recognize and correct the F-PDCCH error of the mobile station generated during the NOI.

### SUMMARY OF THE INVENTION

Accordingly, the present invention has been made to solve the above-mentioned problems occurring in the prior art, and an object of the present invention is to provide an apparatus and a method for preventing a mobile station selected by a base station from malfunctioning by preventing the mobile station from receiving an erroneous control message caused by a reception error of the packet control channel when the base station transmits packet data in a CDMA 2000 1xEV-DV system.

Another object of the present invention is to provide an apparatus and a method for preventing a mobile station selected by a base station from accepting erroneous Walsh mask update information due to a reception error of the packet control channel, which may cause the mobile station to continuously generate an F-PDCH decoding error due to erroneous Walsh mask information if the base station does not retransmit accurate Walsh mask information to the mobile station.

Still another object of the present invention is to provide an apparatus and a method for allowing a mobile station to replace erroneous Walsh mask information with accurate Walsh mask information within a short period of time by inspecting and correcting reliability of a Walsh mask with a predetermined time delay based on an MAC_ID_ALL_Zero value resulting from the F-PDCCH.

Still another object of the present invention is to provide an apparatus and a method capable of preventing a mobile station, which is not selected by a base station, from receiving an erroneous Walsh mask update control message due to a reception error of the packet control channel, thereby minimizing interference and waste of reverse channel resources caused by a malfunction of the mobile station.

In order to accomplish these objects, according to a first aspect of the present invention, there is provided an apparatus for receiving data through channels in a communication system including a first channel for transmitting control information related to a second channel and the second channel for transmitting packet data, the apparatus comprising: a first channel decoder for decoding the first channel and outputting control information; an active Walsh mask storing section for storing a Walsh mask acquired from the control information; a second channel decoder for decoding the second channel using the Walsh mask stored in the active Walsh mask storing section and outputting a decoding result; and a control unit for changing the Walsh mask to a previous Walsh mask if a Walsh mask error is determined according the decoding result.

In order to accomplish these objects, according to a second aspect of the present invention, there is provided a method for receiving data through channels in a communication system including a first channel for transmitting control information related to a second channel and the second channel for transmitting packet data, the method comprising the steps of:

i) obtaining a Walsh mask by decoding the first channel; ii) storing a previous Walsh mask and decoding the second channel using the Walsh mask; iii) inspecting the validity of the Walsh mask according to a decoding result in the second channel; and iv) changing the Walsh mask to the previous Walsh mask if determined that the Walsh mask is invalid according to the decoding results.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view illustrating forward channels aligned between a base station and a mobile station in a conventional CDMA 2000 1xEV-DV system;

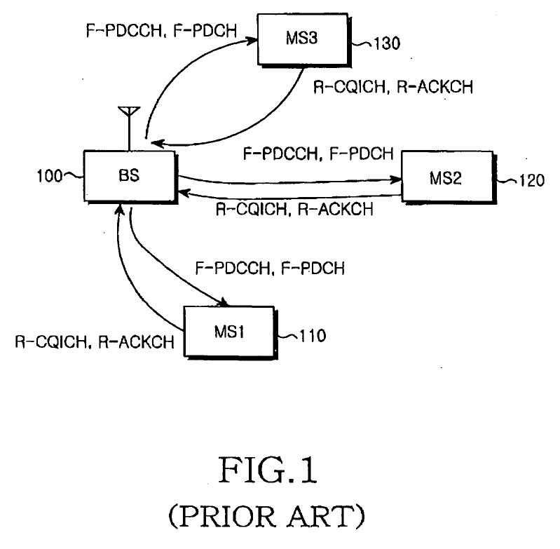

FIG. 2 is a view illustrating an example of a forward packet data control channel (F-PDCCH) used in a conventional CDMA 2000 1xEV-DV system;

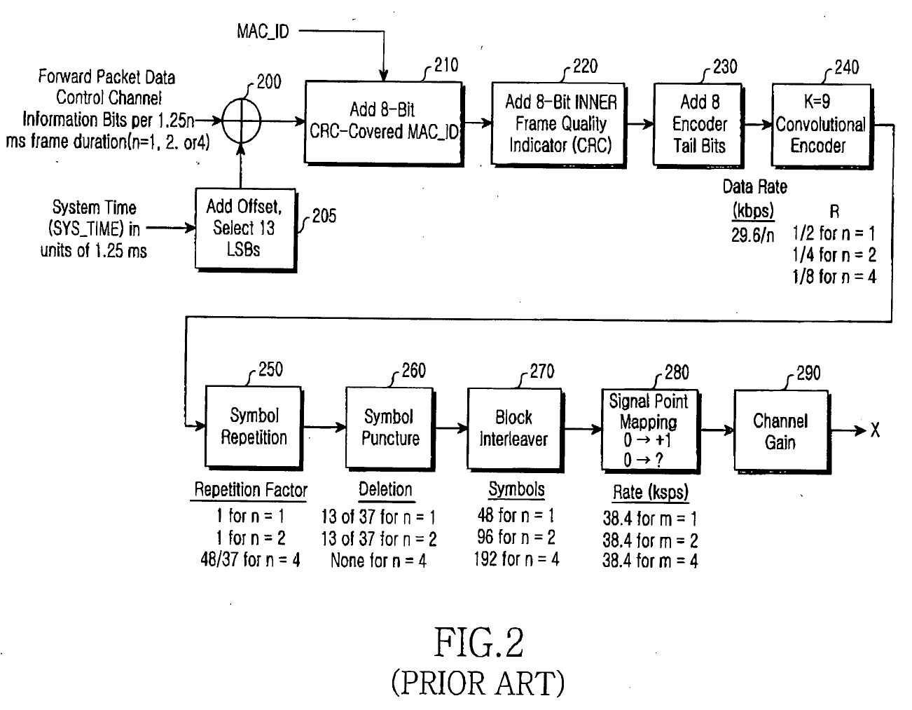

FIG. 3 is a view illustrating structures of a transmitter and a receiver for an F-PDCCH in a conventional CDMA 2000 1xEV-DV employing the F-PDCCH;

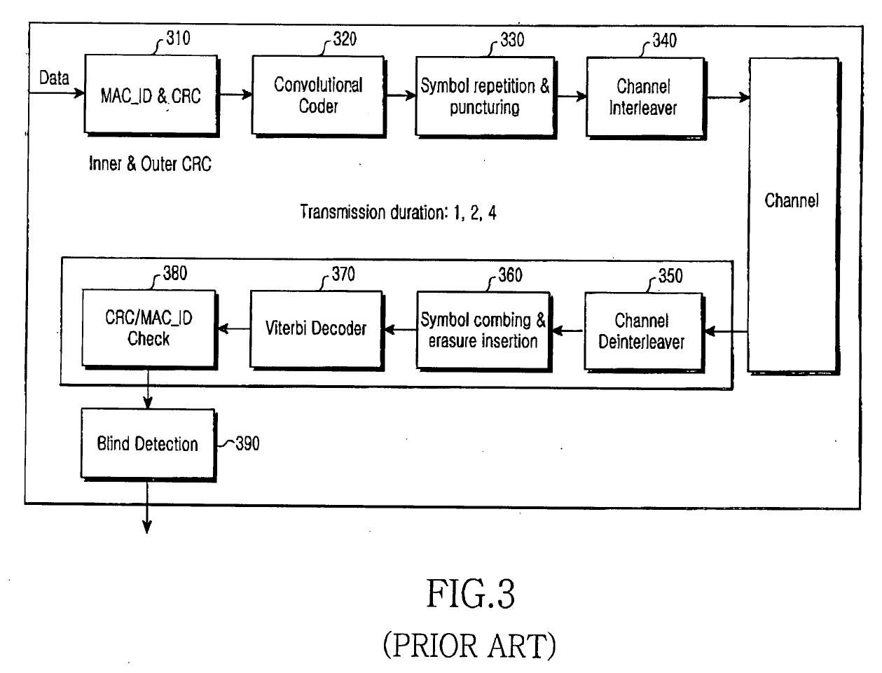

FIG. 4 is a view illustrating an example of non-continuous packet transmission and ACK/NAK transmission between a receiver and transmitter in an FHARQ scheme with four transmission durations (N=4) according to an embodiment of the present invention;

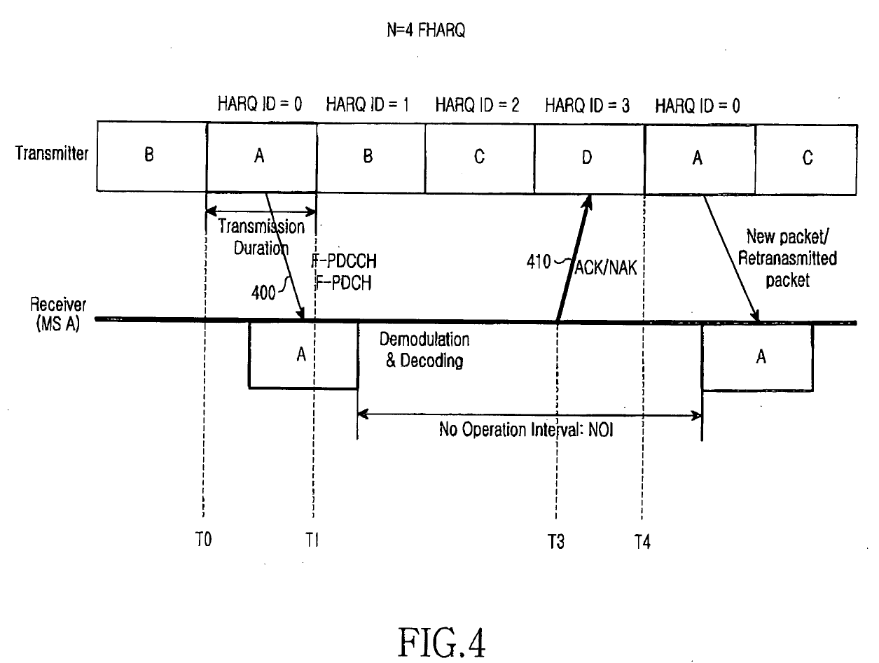

FIG. 5 is a view illustrating another example of non-continuous packet transmission and ACK/NAK transmission between a receiver and transmitter in an FHARQ scheme with four transmission durations (N=4) according to an embodiment of the present invention;

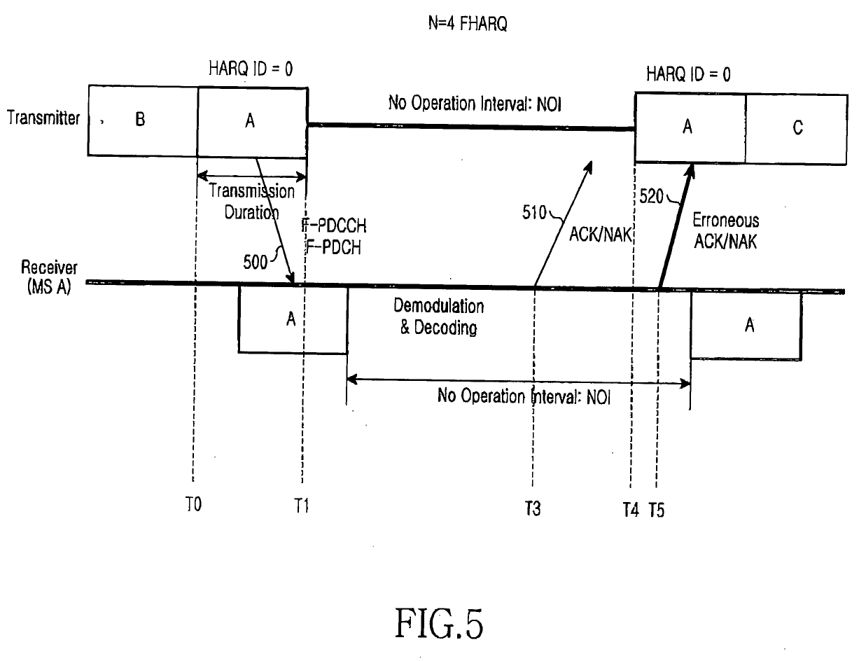

FIG. 6 is a view illustrating one example of continuous packet transmission and ACK/NAK transmission between a receiver and transmitter in an FHARQ scheme with four transmission durations (N=4) according to an embodiment of the present invention;

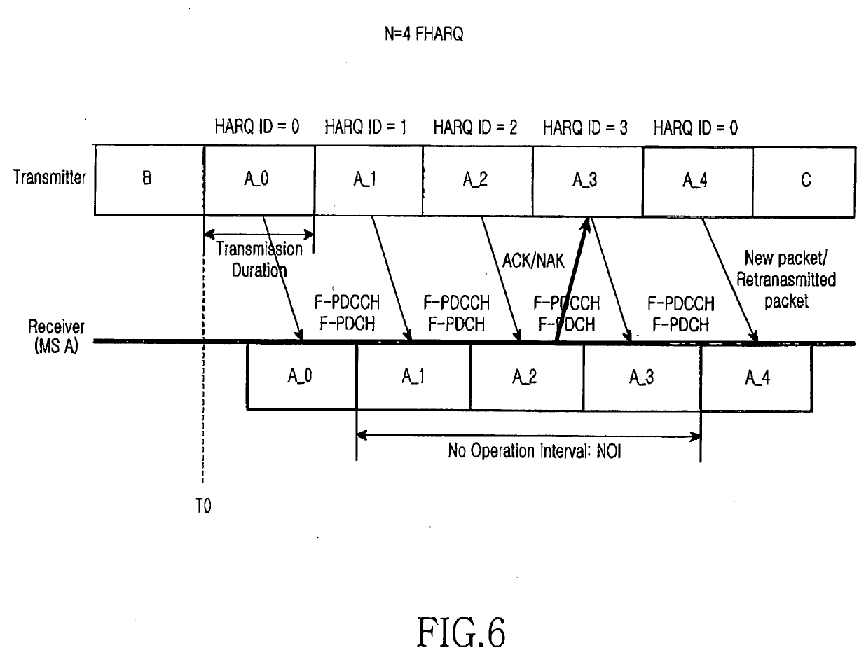

FIG. 7 is a view illustrating a continuous F-PDCH error caused by an F-PDCCH error according to an embodiment of the present invention;

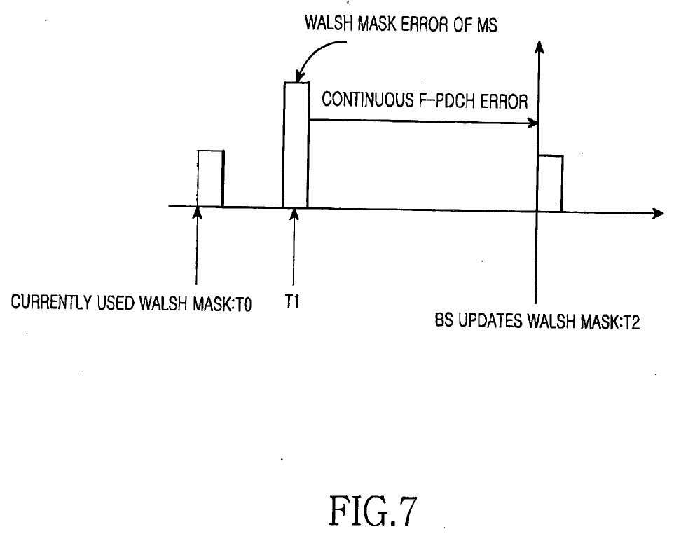

FIG. 8 is a view illustrating a structure of a receiver for updating a Walsh mask according to one embodiment of the present invention;

FIG. 9 is a block diagram illustrating a structure of a receiver for updating a Walsh mask according to one embodiment of the present invention;

FIG. 10 is a detailed view of a WMVS shown in FIG. 9;

FIG. 11 is a view illustrating an operation of a packet data decoding result checking section as a function of time according to an embodiment of the present invention;

FIG. 12 is a flowchart for explaining a method for receiving a forward packet data channel according to one embodiment of the present invention; and

FIG. 13 is a view illustrating an operation of an apparatus for receiving a forward packet data channel as a function of time according to an embodiment of the present invention.

Like reference numbers are used throughout the drawings and refer to like features and structures.

### DETAILED DESCRIPTION OF THE PREFERRED EMBODIMENTS

Hereinafter, embodiments of the present invention will be described with reference to the accompanying drawings.

In the following detailed description, representative embodiments of the present invention will be described. In addition, a detailed description of known functions and configurations incorporated herein will be omitted for the sake of clarity.

The embodiments of the present invention provide an apparatus and a method for allowing a mobile station to replace erroneous Walsh mask information with accurate Walsh mask information within a short period of time by inspecting and correcting reliability of a Walsh mask with a predetermined time delay based on an MAC_ID_ALL_Zero value resulting from a forward packet data control channel (F-FDCCH).

In addition, although embodiments of the present invention suggest an apparatus and a method for receiving forward channels in a mobile station, embodiments of the present invention also include an apparatus and a method for receiving reverse channels in a base station.

Particularly, embodiments of the present invention take an NOI (no operation interval) into consideration.

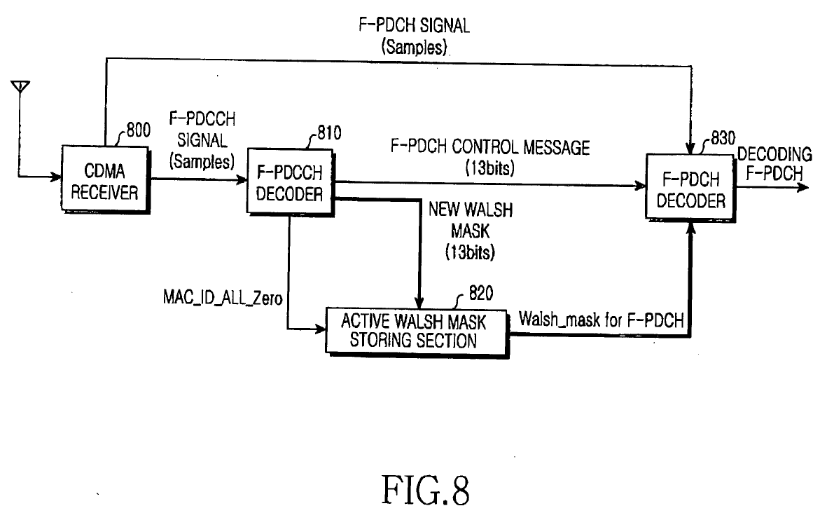

FIG. 8 is a view illustrating a structure of a receiver for updating a Walsh mask according to one embodiment of the present invention.

Referring to FIG. 8, a CDMA receiver 800 is an apparatus for decoding a CDMA signal employed in a CDMA 2000 1xEV-DV system. Although it is not illustrated in figures, the CDMA receiver 800 preferably includes a pseudo-noise (PN) de-spreader. An F-PDCCH decoder 810 decodes the F-PDCCH signal received in the CDMA receiver 800, thereby outputting a 13-bit result and a CRC inspection result. Since embodiments of the present invention are described on the assumption that a receiver determines normal CRCs, the CRC will not be further described below.

If the decoding result of the F-PDCCH decoder 810 shows that MAC_IDs are not all “0”, the 13-bit of the F-PDCCH is used as a control message for demodulating and decoding the F-PDCH. In contrast, if MAC_IDs are all “0”, the 13-bit of the F-PDCCH is used for transferring a bit map in order to update a Walsh mask. In FIG. 8, the “MAC_ID_ALL_Zero” signifies a flag signal, which is set to “1” when the F-PDCCH decoder 810 detects all MAC_IDs as “0”.

An active Walsh mask storing section 820 is a memory or a register for storing the Walsh mask bit map. In general, the Walsh mask storing section 820 includes a register made using software, a register made using flip-flops or a RAM. Accordingly, if all 13-bit MAC_IDs are detected as “0” after the decoding operation of the F-PDCCH decoder 810 with respect to the F-PDCCH transmitted from the base station, it is determined that a control message requesting an update of the Walsh mask defined in the CDMA 2000 1xEV-DV standard has been transmitted, so a new Walsh mask is stored in the active Walsh mask storing section 820. The new Walsh mask is used for decoding and demodulating the F-PDCH. That is, according to the receiver shown in FIG. 8, the Walsh mask is replaced with new one without a time delay depending on an “MAC_ID_ALL_Zero” value resulting from the F-PDCCH.

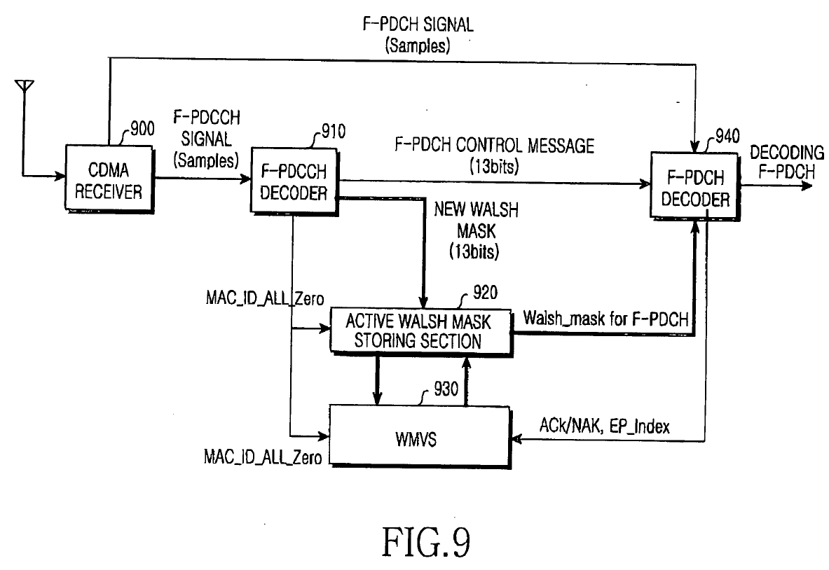

FIG. 9 is a block diagram illustrating a structure of a receiver for updating a Walsh mask according to one embodiment of the present invention. Referring to FIG. 9, the receiver further includes a Walsh mask valid check and selector (WMVS) 930 in addition to the structure of the receiver shown in FIG. 8. The WMVS 930 receives the “MAC_ID_ALL_Zero” output from an F-PDCCH decoder 910, the ACK/NAK information output from an F-PDCH decoder 940, and an encoder packet index (EP_Index) representing an order of encoder packets (EPs), to control the active Walsh mask storing section 920. Herein, the EP_Index is used for allowing the WMVS 930 to recognize an EP including an NAK message transmitted from the F-PDCH decoder. In practice, the NAK message is supposed to be transmitted only when the EP finally includes the NAK message after the decoding operation of the F-PDCH decoder. In general, the WMVS 930 receives and counts the NAK messages related to a sub-packet (SP) from the F-PDCH decoder in order to determine whether the EP includes the NAK message. Since it is unusual that the NAK messages are continuously represented in the same EP, information about the EP is transmitted to the EP_Index in order to determine the Walsh mask error if the NAK messages are continuously represented with regard to the EP. That is, although the EP_Index is used for allowing the F-PDCH decoder to discriminate the EP, it is not necessarily required for the embodiments of the present invention.

The WMVS 930 temporarily stores the previous Walsh mask in order to determine the reliability of a new Walsh mask bit map update message. If the F-PDCH decoder 940 continuously creates an encoder packet NAK (EP_NAK) signal more than a threshold value due to the new Walsh mask bit map update message, the WMVS 930 determines that the previous Walsh mask bit map as an active Walsh mask even if there is no control message transmitted from the base station and stores the active Walsh mask in the active Walsh mask storing section 920. As described above, the EP_NAK can be obtained by utilizing the EP_Index and NAK messages transmitted from the F-PDCH decoder or the WMVS 930 can determine the EP_NAK based on the SP NAK and a maximum retransmission number.

That is, the embodiments of the present invention provides an online/offline Walsh mask convert scheme capable of inspecting and correcting the Walsh mask with a predetermined time delay based on the “MAC_ID_ALL_Zero” value resulting from the F-PDCCH. A time delay value can be predetermined when providing the receiver by taking the threshold value or the channel status into consideration.

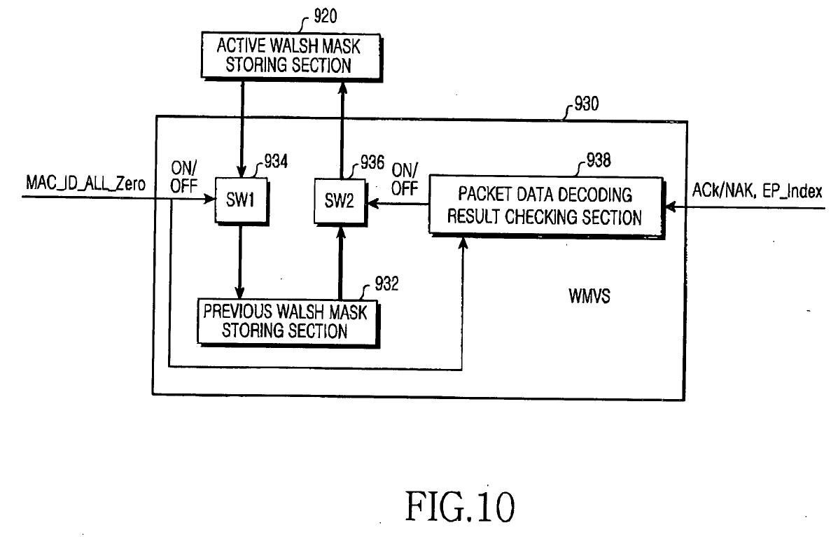

Hereinafter, an internal structure of the WMVS 930 will be described in detail with reference to FIG. 10.

Referring to FIG. 10, a previous Walsh mask storing section 932 is a space for temporarily storing the Walsh mask bit map. The previous Walsh mask storing section 932 includes a register or a memory.

A packet data decoding result checking section 938 includes a counter (EP_NAK_COUNTER) for counting the EP_NAK signals output from the F-PDCH decoder 940 and a threshold value determination section for determining whether the counting number of the counter exceeds a predetermined threshold value. The packet data decoding result checking section 938 controls a switch 936 according the ACK/NAK messages transmitted from the F-PDCH decoder 940 so as to output the Walsh mask bit map temporarily stored in the previous Walsh mask storing section 932 to the active Walsh mask storing section 920.

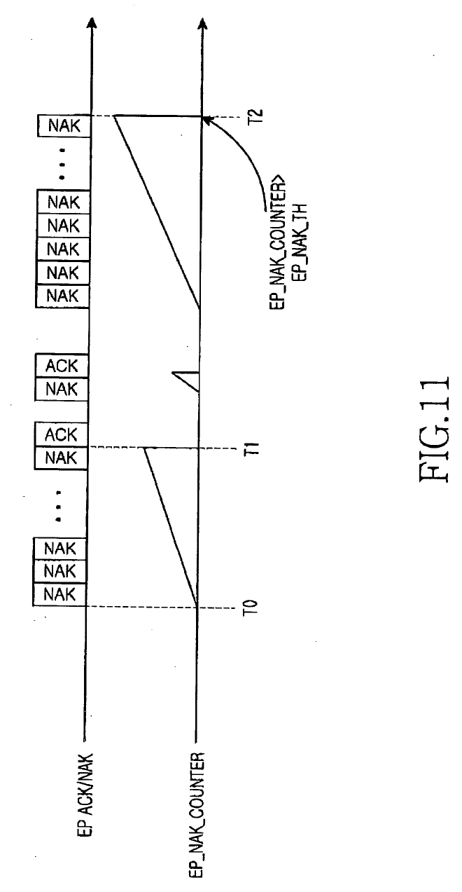

Referring to FIG. 11, the EP_NAK_COUNTER of the packet data decoding result checking section 938 is set to “0” during an initialization procedure. Then, if the F_PDCCH decoder 910 outputs the “MAC_ID_ALL_Zero”, which is set to “1” at the point of T0, that is, if all of the MAC_ID bits are set to “0”, the EP_NAK_COUNTER is initialized into “0”. If the F-PDCH transmits the NAK message even though the F-PDCH decodes a predetermined EP corresponding to a maximum retransmission number, the value of the EP_NAK_COUNTER increases by “+1”. The NAK signifies that the decoding for the EP has been attempted corresponding to the maximum retransmission number, but failed. At this time, the NAK does not mean the NAK with regard to the sub-packet (SP). Accordingly, the value of the EP_NAK_COUNTER may not increase in relation to a retransmitted NAK. As shown in FIG. 11, upon receiving the ACK message from the F-PDCH decoder 940 at the point of T1, the EP_NAK_COUNTER is initialized to “0”. As represented at the point of T2 in FIG. 11, the second switch SW2 936 has a short-circuit or is closed and the EP_NAK_COUNTER is initialized to “0” by means of the threshold value determination section when the value of the EP_NAK_COUNTER exceeds a predetermined threshold value (EP_NAK_TH). The threshold value (EP_NAK_TH) is predetermined when providing the receiver by tanking the channel status and the like into consideration. A procedure for calculating the threshold value (EP_NAK_TH) is not important in the present invention, so it will be omitted.

A first switch SW1 934 shown in FIG. 10 is set to an off state during the initialization procedure and is on/off controlled according to the MAC_ID_ALL_Zero signal output from the F-PDCCH decoder 910. If the MAC_ID_ALL_Zero signal is “1”, that is, if all MAC_ID bits are “0”, the first switch SW1 934 is turned on. If the first switch SW1 934 is turned on, data stored in the active Walsh mask storing section 920 are output to the previous Walsh mask storing section 932.

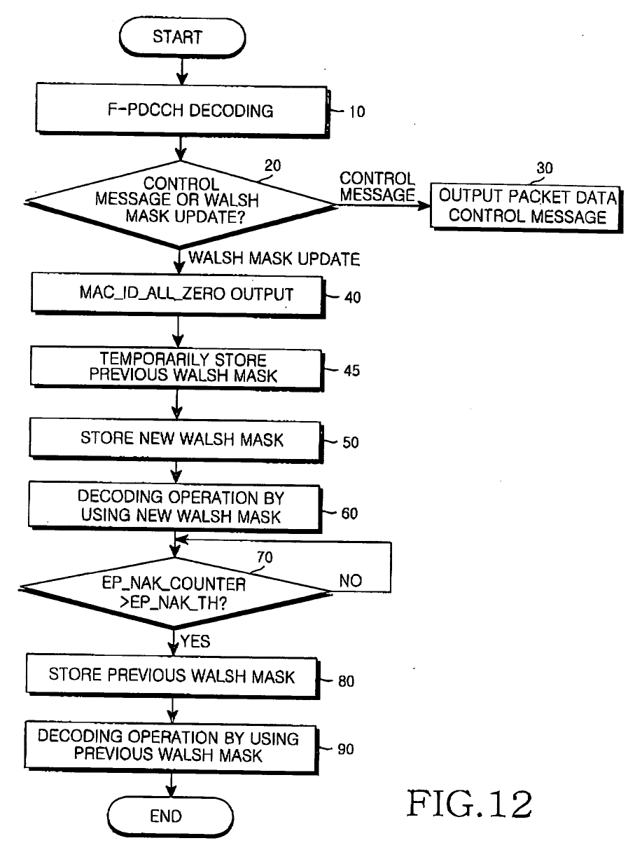

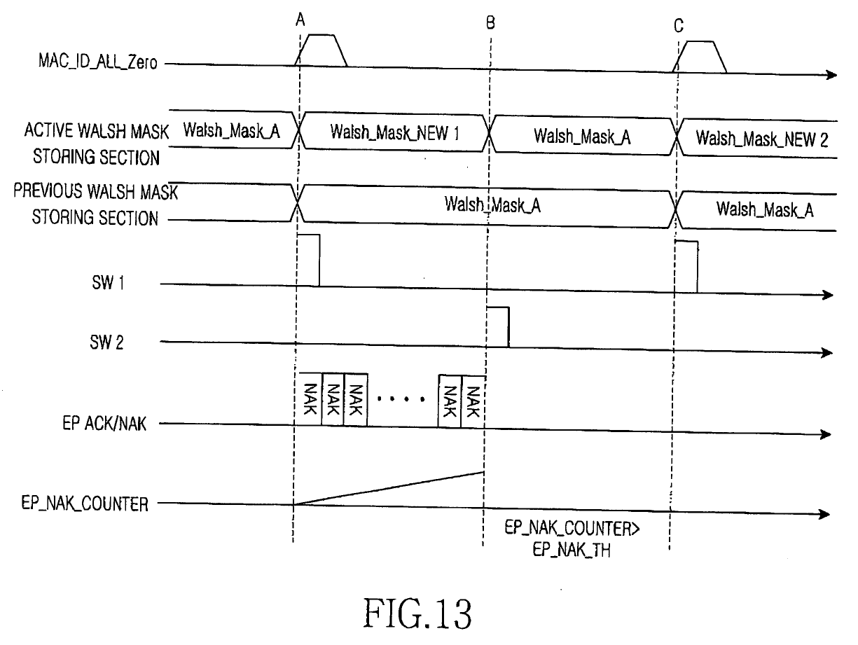

Hereinafter, an operation of a receiver including the WMVS 930 and a method of reducing a control channel false alarms in the receiver will be described with reference to FIGS. 12 and 13.

Referring to FIG. 12, the F-PDCCH decoder 910 receives a packet data control channel signal from the CDMA receiver 800 and decodes the packet data control channel signal, thereby outputting a 13-bit result and a CRC inspection result (step 10).

In step 20, it is determined whether the packet data control channel is control message transmission information or Walsh mask update information according to the result of the decoding operation. That is, it is determined whether all MAC_IDs are “0” depending on the decoding operation of the F-PDCCH decoder 910.

If it is determined that all MAC_IDs are not “0” in step 20, the F-PDCCH decoder 910 outputs the packet data control message to the F-PDCH decoder 940 (step 30). In addition, if it is determined that all MAC_IDs are “0” in step 20, the F-PDCCH decoder 910 transmits the flag signal of MAC_ID_ALL_Zero, which is set to “1”, to the active Walsh mask storing section 920 and the WMVS 930.

Steps 40 to 60 are carried out in the same time corresponding to point A shown in FIG. 13. In step 40, the first switch 934 of the WMVS 930 is turned on as the WMVS 930 receives the MAC_ID_ALL_Zero of “1” so that the previous Walsh mask bit map stored in the active Walsh mask storing section 920 is temporarily stored in the previous Walsh mask storing section 932 (step 45). In step 50, the active Walsh mask storing section 920 stores a new Walsh mask bit map output from the F-PDCCH decoder 910 as the active Walsh mask storing section 920 receives the MAC_ID_ALL_Zero of “1”. In addition, the new Walsh mask bit map output to the active Walsh mask storing section 920 is transmitted to the F-PDCH decoder 940. Thus, the F-PDCH decoder 940 decodes the packet data channel by using the new Walsh mask bit map (step 60). In addition, the EP_NAK_COUNTER of the packet data decoding result checking section 938 is reset to “0” as it receives the MAC_ID_ALL_Zero of “1”.

According to the result of the decoding operation in step 60, the F-PDCH decoder 940 outputs ACK/NACK information and the EP_Index to the packet data decoding result checking section 938. Thus, the EP_NAK_COUNTER of the packet data decoding result checking section 938 increases a counting value according to the number of NAK signals to be received therein. It can be understood from FIG. 13 that the value of the EP_NAK_COUNTER may gradually increase. In addition, the EP_NAK_COUNTER is initialized to “0” when at least one ACK message is transmitted thereto from the F-PDCH decoder.

After the decoding operation is started with the new Walsh mask bit map, the packet data decoding result checking section 938 continuously checks whether the value of the EP_NAK_COUNTER exceeds the predetermined threshold value (EP_NAK_TH) (step 70). If it is determined in step 70 that the number of NAK messages counted by the EP_NAK_COUNTER is greater than the predetermined threshold value (EP_NAK_TH), as represented in point B shown in FIG. 13, the packet data decoding result checking section 938 turns on the second switch 936 (step 80), so that the Walsh mask bit map temporarily stored in the previous Walsh mask storing section 932 is again stored in the active Walsh mask storing section 920.

At this time, the EP_NAK_COUNTER is again initialized to “0” and the F-PDCH decoder 940 may perform the decoding operation by using the previous Walsh mask bit map until the MAC_ID_ALL_Zero signal, which is set to “1”, is transmitted to the F-PDCH decoder 940 (step 90).

Referring to FIG. 13, when the MAC_ID_ALL_Zero signal, which is set to “1”, is retransmitted to the F-PDCH decoder 940 at point C, the F-PDCH decoder 940 may operate as if it is located at point A.

As described above, embodiments of the present invention can reduce the Walsh mask update error caused by the MAC_ID error generated in a noise channel interval or in the service areas of other users, so that the power consumption of a battery used for the mobile terminal can be reduced and reverse channel capacitance of the system can be increased. In addition, the embodiments of the present invention can minimize the probability of false alarms when receiving the F-PDCCH.

While embodiments of the present invention have been shown and described with reference to certain preferred embodiments thereof, it will be understood by those skilled in the art that various changes in form and details may be made therein without departing from the spirit and scope of the invention as defined by the appended claims.

1. An apparatus for receiving data through channels in a communication system including a first channel for transmitting control information related to a second channel and the second channel for transmitting packet data, the apparatus comprising:
a first channel decoder for decoding the first channel and outputting control information;
an active Walsh mask storing section for storing a Walsh mask acquired from the control information;
a second channel decoder for decoding the second channel using the Walsh mask stored in the active Walsh mask storing section and outputting a decoding result; and
a control unit for changing the Walsh mask to a previous Walsh mask if a Walsh mask error is determined according the decoding result.

2. The apparatus as claimed in claim 1, wherein the control unit comprising a packet data decoding result checking section for determining whether the Walsh mask error occurs using the decoding result and a previous Walsh mask storing section for storing a previous Walsh mask.

3. The apparatus as claimed in claim 2, wherein the packet data decoding result checking section increases a packet receiving error counting value if the decoding result represent a decoding failure and determines the Walsh mask error occurrence if the packet receiving error counting value is larger than a predetermined threshold value

4. The apparatus as claimed in claim 3, wherein the packet data decoding result checking section initializes the counting value if decoding result represent a decoding success.

5. The apparatus as claimed in claim 1, wherein the decoding result represents ACK if the decoding of the second channel is successful and represents NACK if the decoding of the second channel is failure.

6. A method for receiving data through channels in a communication system including a first channel for transmitting control information related to a second channel and the second channel for transmitting packet data, the method comprising the steps of:
i) obtaining a Walsh mask by decoding the first channel;
ii) storing a previous Walsh mask and decoding the second channel using the Walsh mask;
iii) inspecting the validity of the Walsh mask according to a decoding result in the second channel; and
iv) changing the Walsh mask to the previous Walsh mask if determined that the Walsh mask is invalid according to the decoding results.

7. The method as claimed in claim 6, wherein, if the decoding result represents a decoding failure in step iii), a packet receiving error counting value is increased and it is determined that the Walsh mask is invalid if the packet receiving error counting value is larger than a predetermined threshold value.

8. The method as claimed in claim 7, wherein the packet receiving error counting value is initialized if the decoding result represent a decoding success.

9. The method as claimed in claim 6, wherein the decoding result represents ACK if the decoding of the second channel is successful and represents NACK if the decoding of the second channel is failure.
